(19) United States
(12) Patent Application Publication
(10) Pub. No.: US 2006/0117069 A1
(43) Pub. Date: Jun. 1, 2006

(54) SYSTEM, METHOD, AND ARTICLE OF MANUFACTURE FOR MODIFYING RECORDS IN A DATABASE

(75) Inventor: Cees Van Der Leeden, Lommel (BE)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/904,820

(22) Filed: Nov. 30, 2004

(51) Int. Cl. G06F 17/30

(52) U.S. Cl. 707/200

(57) ABSTRACT

A system and a method for modifying a data record in a database are provided. The system allows a user to view a proposed change to the data record in the database during a data synchronization process of a first computer and a second computer. Further, the system allows the user to either approve or reject the proposed change to the data record prior to changing the data record based on the proposed change.

### BACKGROUND OF THE INVENTION

A personal data assistant (PDA) has been developed that allows information stored in the PDA to be synchronized with information stored on a computer. A current synchronization process, however, does not allow a user to examine the proposed updates to information stored in the computer during the synchronization process to allow the user to either accept or reject the proposed changes prior to updating the information. Thus, when incorrect information is inadvertently stored in the PDA, the incorrect information is automatically stored in the computer during the synchronization process.

Accordingly, there exists a need for a system and a method for synchronizing a first computer database with external data from a second computer that allows a user to view proposed changes to the database and either accept or reject the proposed changes prior to modifying the data in the database.

### BRIEF DESCRIPTION OF THE INVENTION

A method for modifying a data record in a database associated with a first computer in accordance with an exemplary embodiment is provided. The first computer operably communicates with a second computer. The method includes sending a first message from the second computer to the first computer having a task identifier identifying at least a first data record having at least a first data unit. The first data record is stored in the database. The method further includes retrieving the first data record from the database utilizing the first computer and sending a second message having the task identifier and the first data unit to the second computer. The method further includes inputting a first input value using the second computer for modifying the first data unit. The method further includes generating a third message having the task identifier and the first input value utilizing the second computer. The method further includes sending the third message containing the task identifier and the first input value from the second computer to the first computer. The method further includes querying a user for a second selection value indicating that the task identifier and the first data unit are either approved or rejected by the user. The method further includes modifying the first data unit in the first data record of the database based on the first input value when the second selection value indicates that the task identifier and the first data unit are approved by the user.

A system for modifying a data record in a database in accordance with another exemplary embodiment is provided. The system includes a first computer configured to operably communicate with a second computer. The first computer is operably coupled to the database having a first data record. The second computer is configured to send a first message to the first computer having a task identifier identifying at least the first data record having at least a first data unit. The first computer is further configured to retrieve the first data record from the database and to send a second message having the task identifier and the first data unit to the second computer. The first computer is further configured to receive a first input value from a user for modifying the first data unit. The second computer is further configured to generate a third message having the task identifier and the first input value. The second computer is further configured to send the third message containing the task identifier and the first input value to the first computer. The first computer is further configured to query a user for a second selection value indicating that the task identifier and the first data unit are either approved or rejected by the user. The first computer is further configured to modify the first data unit in the first data record of the database based on the first input value when the second selection value indicates that the task identifier and the first data unit are approved by the user.

An article of manufacture in accordance with another exemplary embodiment is provided. The article of manufacture includes a computer storage medium having a computer program encoded therein for modifying a data record in a database associated with a first computer. The first computer operably communicates with a second computer. The computer storage medium includes code for sending a first message from the second computer to the first computer having a task identifier identifying at least a first data record having at least a first data unit. The first data record is stored in the database. The computer storage medium further includes code for retrieving the first data record from the database utilizing the first computer and sending a second message having the task identifier and the first data unit to the second computer. The computer storage medium further includes code for inputting a first input value using the second computer for modifying the first data unit. The computer storage medium further includes code for generating a third message having the task identifier and the first input value on the second computer. The computer storage medium further includes code for sending the third message containing the task identifier and the first input value from the second computer to the first computer. The computer storage medium further includes code for querying a user for a second selection value indicating that the task identifier and the first data unit are either approved or rejected by the user. The computer storage medium further includes code for modifying the first data unit in the first data record of the database based on the first input value when the second selection value indicates that the task identifier and the first data unit are approved by the user.

Other systems and/or methods according to the embodiments will become or are apparent to one with skill in the art upon review of the following drawings and detailed description. It is intended that all such additional systems and methods be within the scope of the present application, and be protected by the accompanying claims.

### BRIEF DESCRIPTION OF THE DRAWINGS

FIG. 1 is a block diagram of a system for modifying a data record in a database in accordance with an exemplary embodiment;

FIG. 2 depicts a first message that is transmitted from a first computer to second computer in the system of FIG. 1;

FIG. 3 depicts a second message that is transmitted from the second computer to the first computer in the system of FIG. 1;

FIG. 4 depicts a third message that is transmitted from the first computer to the second computer in the system of FIG. 3;

FIG. 5 depicts a database operably coupled to a computer in the system of FIG. 1;

FIGS. 6 and 7 are flowcharts of a method for modifying a data record in a database in accordance with another exemplary embodiment.

### DETAILED DESCRIPTION OF THE INVENTION

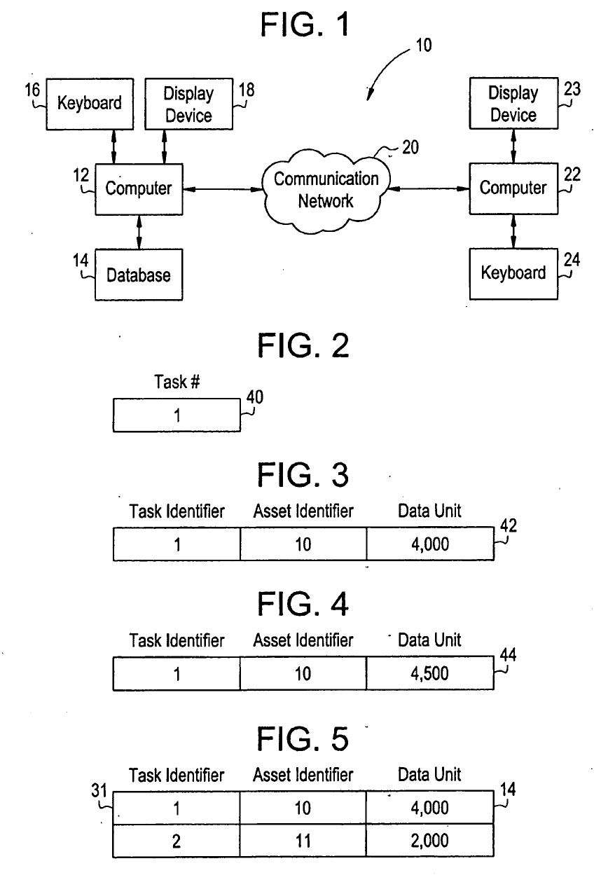

Referring to FIG. 1, a system 10 for synchronizing data in computers 12 and 22 is provided. The system 10 includes a computer 12, the database 14, a keyboard 16, a display device 18, a communication network 20, the computer 22, a display device 23, and a keyboard 24. For purposes of discussion, a computer is defined as an electronic device that accepts and processes information mathematically according to instructions. A database is defined as a computer file containing at least one data record. A communication network is defined as at least one device or communication channel configured to transmit a signal from a first device to a second device. The task identifier is defined as a number or name identifying a data gathering/verification task associated with a physical asset. An asset identifier is defined as a number or name that is associated with a physical asset. A data unit is defined as portion of data associated with the physical asset.

Referring to FIGS. 1-4, the computer 12 is provided to communicate with the computer 22 via the communication network 20. In particular, the computer 12 is configured to receive a first message from the computer 22 having a task identifier. The computer 12 is configured to receive a message 40 having a task identifier “1” associated with a predetermined physical asset. Further, the computer 12 is configured to access a record in the database 14 having a predetermined task identifier, an asset identifier, and a data unit in response to a data request message from the computer 22. For example, in response to receiving message 40, computer 12 accesses the record 31 in the database 14 having a task identifier “1”. Further, the computer 12 is configured to transmit a second message to the computer 22 having the task identifier, the asset identifier and the data unit contained in the accessed data record. For example, computer 22 transmits the message having the task identifier “1”, the asset identifier “10”, and the data unit “4000” contained in the data record 31 to the computer 22.

The computer 22 is provided to communicate with the computer 12 via the communication network 20 and to allow a user to modify a received data unit for updating a data record in the database 14. For example, the computer 22 transmits the message 40 to the computer 12 that induces the computer 12 to return the message 42 to the computer 22. Thereafter, the computer 22 displays the contents of the second message on a display device 23 and allows a user of the computer 22 to input an input value indicating a proposed change to a data unit in the message 42. For example, in response to receiving the message 42 the computer 22 displays the contents of the message 42 including the task identifier “1”, the asset identifier “10”, and the data unit “4000” and allows a user to input an input value “4500” that is indicative of a proposed change to the data unit “4000” in the message 42. Thereafter, the computer 22 generates a third message containing the task identifier, the asset identifier, and the input value that is transmitted to the computer 12. For example, the computer 22 generates the message 44 containing the task identifier “1”, the asset identifier “10”, and the input value “4500” that is transmitted to the computer 12.

The computer 12 is further configured to receive a third message from the computer 22 having at least one updated data unit for modifying a data record in the database 14. For example, the computer 12 is configured to receive the message 44 from the computer 22 having the task identifier “1”, the asset identifier “10” and the data unit “4500”. Thereafter, the computer 12 is configured to display the message 44 on the display device 18. Further, the computer 12 is configured to query a user on the display device 18 of the computer 12 to indicate whether the task identifier, the asset identifier, and the data unit contained within the message 44 is approved or rejected by the operator. When the message 44 is approved by the operator, the computer 12 accesses the record 31 in the database 14 using the task identifier “1” contained in the message 44. Further, the computer 12 changes the data unit “4000” to “4500” in the record 31, wherein the data unit “4500” was received in the message 44. Alternately, when the message 44 is rejected by an operator, the computer 12 removes the message 44 from internal memory (not shown). It should be noted that the operator utilizes predetermined criteria for determining whether the task identifier, the asset identifier, and the data unit is to be approved or rejected. For example, an operator can compare a data unit in the message 44 to a predetermined range of values to determine whether the data unit is a valid data unit.

The display device 18 is provided to display proposed changes to a least one data record in the database 14 for an operator to view. The display device 18 is operably coupled to the computer 12.

The keyboard 16 is provided to allow a user of the computer 12 to make selections for either approving or rejecting proposed changes to at least one data record in the database 14. The keyboard 16 is operably coupled to the computer 12.

The communication network 20 is provided to route messages between the computer 12 and the computer 22. The communication network 20 is operably coupled to both the computer 12 and the computer 22.

The display device 23 is provided to display a received message from the computer 12 for the operator to view. The display device 23 is operably coupled to the computer 22

The keyboard 24 is provided to allow a user of the computer 22 to input a value indicative of a proposed change to at least one record in the database 14. The keyboard 24 is operably coupled to the computer 22.

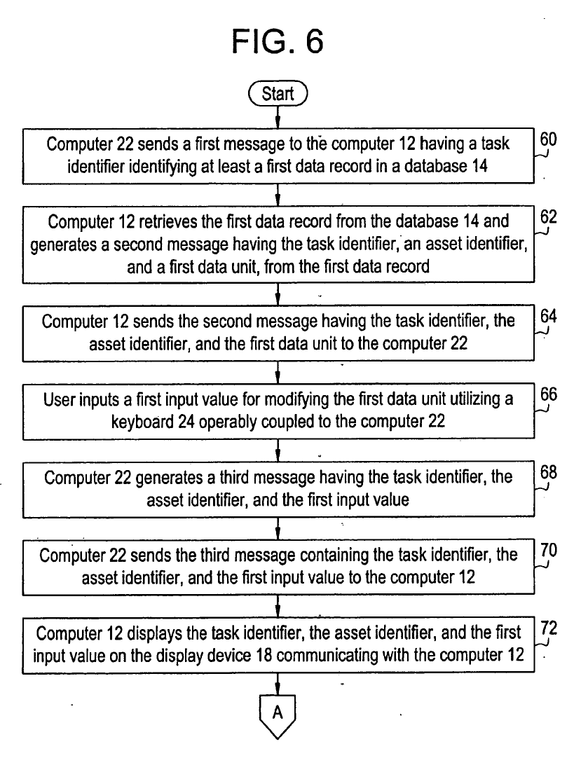

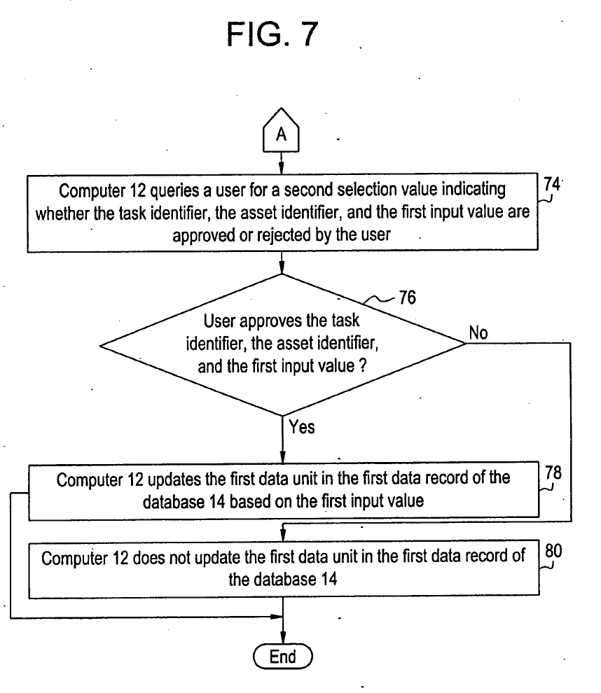

Referring to FIGS. 6-7, a method for modifying a data record in a database will now be explained. The method is implemented in one or more software programs that are executed on the system 10. It should be noted that although each of the messages described below includes only one data unit, each of the messages could alternately include a plurality of data units associated with a physical asset. Further, although only one message is transmitted between the computers 12, 22 at a time, each of the computers could transmit a plurality of messages relating to predetermined tasks, before receiving response messages from the other computer. Further, although only one data record is updated below in the database 14 for purposes of simplicity, the method can be iteratively executed to allow a plurality of records to be updated in the database 14.

At step 60, the computer 22 sends the message 40 to the computer 12 having a task identifier “1” identifying data record 31 in the database 14.

At step 62, the computer 12 retrieves the data record 31 from the database 14 and generates a message 42 having the task identifier “1”, an asset identifier “10”, and a data unit “4000”, from the data record 31.

At step 64, the computer 12 sends the message 42 having the task identifier “1”, the asset identifier “10”, and the data unit “4000” to the computer 22.

At step 66, the user inputs an input value “4500” for modifying the data unit “4000” utilizing the keyboard 24 operably coupled to the computer 22.

At step 68, the computer 22 generates the message 44 having the task identifier “1”, the asset identifier “10”, and the input value “4500”.

At step 70, the computer 22 sends the message 44 containing the task identifier “1”, the asset identifier “10”, and the input value “4500” to the computer 12.

At step 72, the computer 12 displays the task identifier “1”, the asset identifier “10”, and the input value “4500” on the display device 18 communicating with the computer 12. In an alternate embodiment, a voice synthesizer operably coupled to the computer 12 generates a voice message indicating the task identifier “1” and the input value “4500.” In another alternate embodiment, the computer 12 generates an electronic message having the task identifier “1” and the input value “4500.” For example, the electronic message can comprise an email message, or a facsimile message, an instant messaging message, or the like.

At step 74, the computer 12 queries a user for a selection value indicating whether the task identifier “1”, the asset identifier “10”, and the input value “4500” are approved or rejected by the user.

At step 76, the computer 12 makes determination as to whether the user has approved the task identifier “1”, the asset identifier “10”, and the input value “4500”. If the value of step 76 equals “yes”, the method advances to step 78. Otherwise, the method advances to step 80.

At step 78, the computer 12 updates or replaces the data unit “4000” in the data record 31 of the database 14 to the input value “4500”.

At step 80, the computer 12 does not update the data unit “4000” in the data record 31. After either of steps 78, 80, the method is exited.

The system and the method for modifying a data record in a database provide a substantial advantage over other systems and methods. In particular, the system and method provide a technical effect of allowing a user to view proposed changes to the database and either accept or reject the proposed changes prior to modifying the data in the database when synchronizing the computer database with external data.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and/or executed by a computer, the computer becomes an apparatus for practicing the invention. When implemented on a general-purpose microprocessor, the computer program code segments configure the microprocessor to create specific logic circuits.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

What is claimed is:

1. A method for modifying a data record in a database associated with a first computer, the first computer operably communicating with a second computer, comprising:
sending a first message from the second computer to the first computer having a task identifier identifying at least a first data record having at least a first data unit, the first data record being stored in the database;
retrieving the first data record from the database utilizing the first computer and sending a second message having the task identifier and the first data unit to the second computer;
inputting a first input value using the second computer for modifying the first data unit;
generating a third message having the task identifier and the first input value utilizing the second computer;
sending the third message containing the task identifier and the first input value from the second computer to the first computer;
querying a user for a second selection value indicating that the task identifier and the first data unit are either approved or rejected by the user; and
modifying the first data unit in the first data record of the database based on the first input value when the second selection value indicates that the task identifier and the first data unit are approved by the user.

2. The method of claim 1, further comprising displaying the task identifier and the first input value on a display device communicating with the first computer.

3. The method of claim 1, further comprising generating a voice message indicating the task identifier and the first input value utilizing a voice-synthesizer operably coupled to the first computer.

4. The method of claim 1, further comprising generating an electronic message having the task identifier and the first input value using the first computer.

5. The method of claim 1, further comprising disposing of the third message when the second selection value indicates that the task identifier and the first data unit are not approved by the user.

6. The method of claim 1, wherein the first data record further comprises an asset identifier, the second and third messages further comprising the asset identifier, the querying step comprising:
querying the user for the second selection value indicating that the task identifier, the asset identifier, and the first data unit are either approved or rejected by the user.

7. The method of claim 1, wherein the first data unit comprises data associated with a physical asset.

8. The method of claim 7, wherein the physical asset comprises at least one of an electrical device, a mechanical device, and an electro-mechanical device.

9. A system for modifying a data record in a database, comprising:
a first computer configured to operably communicate with a second computer, the first computer being operably coupled to the database, the database having a first data record, the second computer is configured to send a first message to the first computer having a task identifier identifying at least the first data record having at least a first data unit, the first computer is configured to retrieve the first data record from the database and to send a second message having the task identifier and the first data unit to the second computer, the first computer is further configured to receive a first input value from a user for modifying the first data unit, the second computer is further configured to generate a third message having the task identifier and the first input value, the second computer is further configured to send the third message containing the task identifier and the first input value to the first computer, the first computer is further configured to query a user for a second selection value indicating that the task identifier and the first data unit are either approved or rejected by the user, the first computer is further configured to modify the first data unit in the first data record of the database based on the first input value when the second selection value indicates that the task identifier and the first data unit are approved by the user.

10. The system of claim 9, further comprising a display device operably coupled to the first computer, the first computer further configured to display the task identifier and the first input value on the display device.

11. The system of claim 9, further comprising a voice-synthesizer operably coupled to the first computer, the voice synthesizer configured to generate a voice message indicating the task identifier and the first input value.

12. The system of claim 9, wherein the first computer is further configured to generate an electronic message having the task identifier and the first input value.

13. The system of claim 9, wherein the first computer is further configured to dispose of the third message when the second selection value indicates that the task identifier and the data unit are not approved by the user.

14. The system of claim 9, wherein the first data record further comprises an asset identifier, the second and third messages further comprising the asset identifier, the first computer further configured to query the user for the second selection value indicating that the task identifier, the asset identifier, and the first data unit are either approved or rejected by the user.

15. The system of claim 9, wherein the first data unit comprises data associated with a physical asset.

16. The system of claim 15, wherein the physical asset comprises at least one of an electrical device, a mechanical device, and an electro-mechanical device.

17. An article of manufacture, comprising:
a computer storage medium having a computer program encoded therein for modifying a data record in a database associated with a first computer, the first computer operably communicating with a second computer, the computer storage medium comprising:
code for sending a first message from the second computer to the first computer having a task identifier identifying at least a first data record having at least a first data unit, the first data record being stored in the database;
code for retrieving the first data record from the database utilizing the first computer and sending a second message having the task identifier and the first data unit to the second computer;
code for inputting a first input value using the second computer for modifying the first data unit;
code for generating a third message having the task identifier and the first input value on the second computer;
code for sending the third message containing the task identifier and the first input value from the second computer to the first computer;
code for querying a user for a second selection value indicating that the task identifier and the first data unit are either approved or rejected by the user; and
code for modifying the first data unit in the first data record of the database based on the first input value when the second selection value indicates that the task identifier and the first data unit are approved by the user.

18. The article of manufacture of claim 17, wherein the computer storage medium further comprises code for disposing of the third message when the second selection value indicates that the task identifier and the first data unit are not approved by the user.

19. The article of manufacture of claim 17, wherein the first data record further comprises an asset identifier, the second and third messages further comprising the asset identifier, the computer storage medium further comprising code for querying the user for the second selection value indicating that the task identifier, the asset identifier, and the first data unit are either approved or rejected by the user.

20. The article of manufacture of claim 17, wherein the first data unit comprises data associated with a physical asset.
